(19) United States
(12) Patent Application Publication
(10) Pub. No.: US 2009/0222295 A1
(43) Pub. Date: Sep. 3, 2009

(54) METHOD FOR MANAGING AN INFORMATION TECHNOLOGY SERVICE ACCOUNT

(75) Inventor: Fred Pimentel, San Mateo, CA (US)

Correspondence Address: FLIESLER MEYER LLP, 650 CALIFORNIA STREET, 14TH FLOOR, SAN FRANCISCO, CA, 94108, US

(73) Assignee: BEA SYSTEMS, INC., San Jose, CA (US)

(21) Appl. No.: 12/039,663

(22) Filed: Feb. 28, 2008

(51) Int. Cl. G06Q 10/00

(52) U.S. Cl. 705/7

(57) ABSTRACT

A method to manage an information technology service account comprises engaging a customer to establish the information technology service account and engaging in four phases of management. In the reactive phase, the steps of training the customer on support and assessing technical needs of the customer are performed. In the proactive phase, the steps of establishing a problem reporting procedure, deploying the problem reporting procedure to the customer, identifying known issues of the information technology service account based at least in part on the problem reporting procedure, identifying solutions to the identified known issues are performed. In the planning phase, the steps of determining additional or substitutive tools for the information technology service account based on the problem reporting procedure, querying product releases of the customer, querying technology roadmap of the customer, determining additional or substitutive tools based on the product releases and technology roadmap are performed. In the maintenance phase, the steps of collecting customer feedback data, and determining modification of one or both of steps of the previous phases and one or more tools based on the customer feedback data.

### TECHNICAL FIELD

The invention relates to business account management and information technology infrastructure management.

### BACKGROUND

An organization's Information Technology (“IT”) infrastructure is important to the organization's success. Interruptions in business continuity can detrimentally affect an organization's revenue, inventory, customer relationships, productivity, and reputation. Organizations are often engaged by companies that develop or manage infrastructure software to help manage the availability, stability, and adaptability of the IT infrastructure.

An engaging company (referred to hereinafter as a vendor) may be tasked to reduce the impact of downtime, improve IT infrastructure operational efficiency, and/or enable new mission-critical capabilities. Commonly, an account manager representing the vendor develops a support strategy for the organization on an ad hoc basis. An engagement model applied by a vendor to some or all customers (i.e., one or more organizations engaging the vendor) can be desirable to provide more consistent and efficient performance across accounts managed by different account managers and across accounts spanning different industries.

### BRIEF DESCRIPTION OF THE DRAWINGS

FIG. 1A is a flowchart describing a reactive phase of an embodiment of a method of engaging a customer in accordance with the present invention.

FIG. 1B is a flowchart describing assessment of customer needs.

FIG. 2 is a flowchart describing a proactive phase of the embodiment of a method of engaging a customer.

FIG. 3 is a flowchart describing a planning phase of the embodiment of a method of engaging a customer.

FIG. 4 is a flowchart describing a maintenance phase of the embodiment of a method of engaging a customer.

### DETAILED DESCRIPTION OF THE DRAWINGS

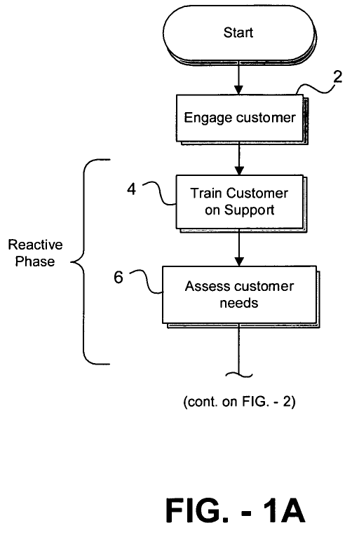

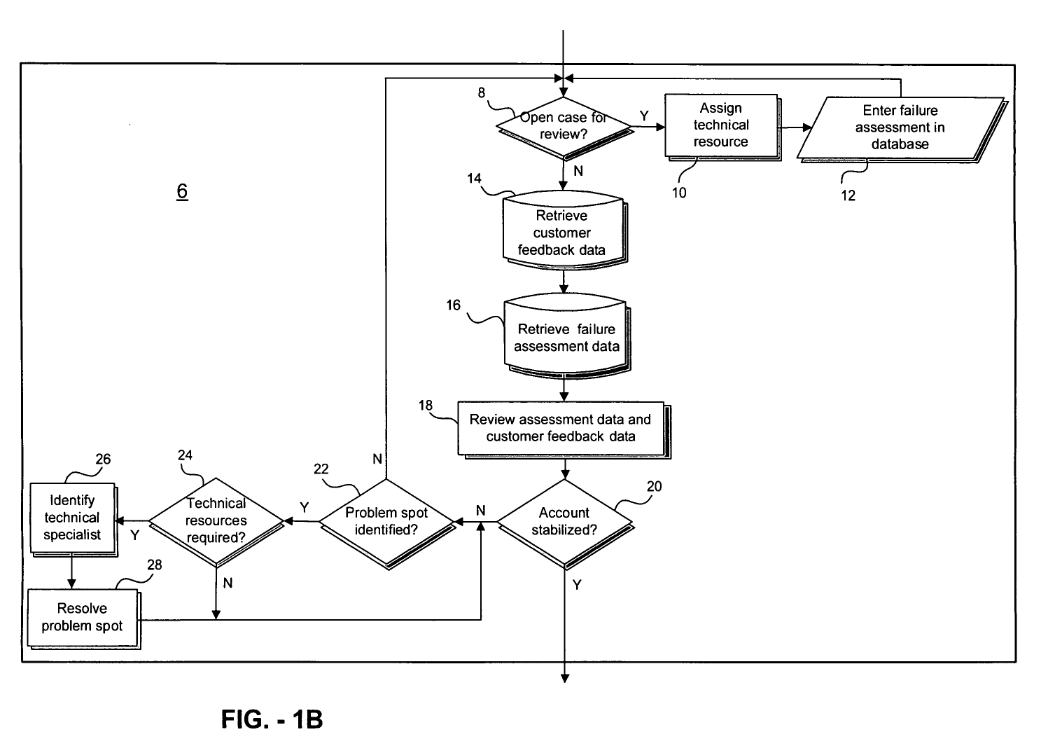

Referring to FIGS. 1A and 1B, a flowchart illustrates a first phase of an engagement model applying an embodiment of a method of managing an information technology (IT) service account in accordance with the present invention. The method begins when a customer is engaged by the vendor (step 2). The customer may have an IT infrastructure managed by the customer or managed by another vendor, or the customer and/or the customer's IT infrastructure may be nascent or restructuring. Once the customer is engaged the first phase (also referred to herein as the reactive phase) begins. The vendor starts by training the customer on support (step 4). For example, the customer may be instructed on problem escalation procedures and data entry procedures. The vendor is then tasked to assess customer needs (step 6). An initial step in assessing a customer's needs may include determining whether any open cases (also referred to herein as open tickets) exist (Step 8). An open case can be an unresolved, documented problem. An open case will commonly be cataloged and its status is monitored until the problem is resolved, at which time the open case can be closed. Open cases are logged by the customer in a case database by using either an automated system (e.g., a designated website established to collect case data, an automated telephone system) or a semi-automated system (e.g., a customer support-staffed telephone system). The vendor further assigns the open case to a technical resource for resolution (step 10). The technical resource may be a software engineer, a hardware engineer, or alternatively the technical resource may be some other resource, such as a trainer for familiarizing the customer's technical staff with the vendor's products. The technical resource assesses the failure and a source of the failure and enters the information in a database (Step 12). The vendor repeats the steps until all of the open cases are reviewed and data is entered.

If all open cases have been reviewed, the vendor retrieves any existing customer feedback data from a database (step 14). Customer feedback data may be captured in service scorecards, questionnaires, solicited or unsolicited comments, etc. In other embodiments, the customer feedback data can be collected prior to reviewing open cases, or contemporaneously with reviewing open cases. The failure assessment data accumulated during open case review (also referred to herein as case data) is likewise retrieved (Step 16). The customer feedback data and case data can be aggregated in a central database particular to the customer to enable identification of patterns in the customer's aggregate data (Step 18). The central database can be a networked database, such as a website. Identified patterns can indicate whether the account has stabilized (Step 20). For example, identified patterns can be correlated with a level of customer proficiency with the IT infrastructure and/or technical capability of the IT infrastructure to service the customer's needs. The vendor can identify whether a problem spot exists by reviewing the case data and the customer feedback data combined and analyzed using trend analysis techniques known in the art. A problem spot may be architectural or may be related to a level of skill and knowledge of the customer's technical staff. Architecture refers to the engagement model, including deliverables (e.g., as shown in FIGS. 1A, and 2-4) and sub-deliverables (e.g., as shown in FIG. 1B). If the architecture is determined to be insufficient, for example based on the results of the problem reporting procedure, the architecture can be modified by adding to or deleting from one of the deliverables or sub-deliverables.

If a problem spot is identified (Step 22) the vendor can determine whether a technical resource is required (Step 24). If technical resources are required the vendor identifies a technical specialist best able to address a problem spot (Step 28). Resolution may require software and hardware adjustments if the problem spot is architectural, or may include recommendations for customer adjustments to the customer's technical staff to improve the customer's IT infrastructure. If a technical resource is not required for resolving a problem spot, the problem spot can be further monitored. If aggregate data review identifies patterns that indicate account instability, but does not identify architectural problem spots, the account can continue to be monitored for patterns.

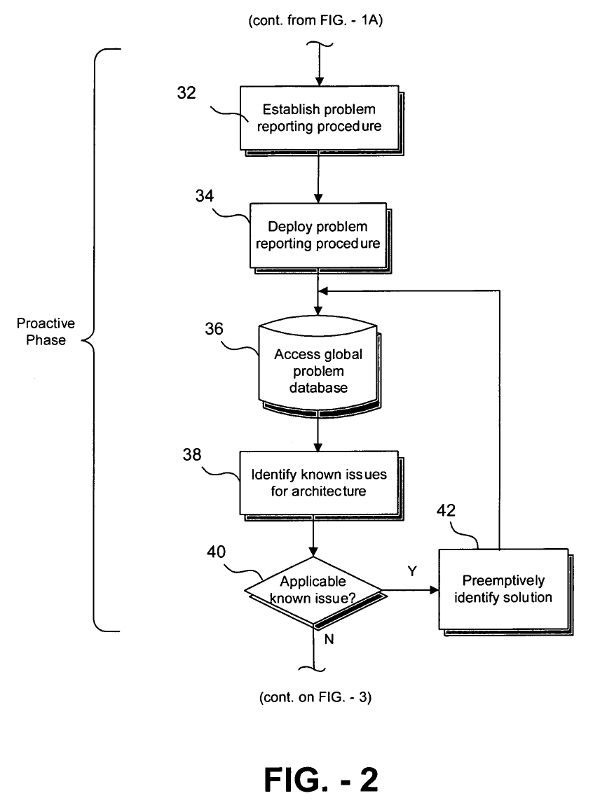

Referring to FIG. 2, the proactive phase begins once the reactive phase is completed. Alternatively, the proactive phase can begin at some threshold level of achievement (for example in reducing identified patterns) during the reactive phase. The reactive phase may continue being implemented in such embodiments. The vendor begins the proactive phase by establishing a problem reporting procedure (step 32). The problem reporting procedures targets information that the vendor determines is most likely to resolve future open cases as well as identify potential problems that have not yet occurred. Standardizing the reporting procedure can allow for more complete and uniform data collection so that steps of the method of managing the information technology service account are more accurate and effective. The problem reporting procedure can be particularized for the industry and/or the customer. For example, a customer that is a network service provider may require a problem reporting procedure tailored to request additional details that would preferentially identify and highlight potential problems with service continuity (i.e., network uptime).

The problem reporting procedure is deployed (step 34) and data generated by the problem reporting procedure are collected in a database and subsequently accessed from the database (step 36). The data are optionally pooled with historical data, for example the case data and customer feedback data described above. The vendor accesses the problem reporting database and monitors the service account for impending failures based on the gathered data in the problem reporting database (step 38). If there are impending failures associated with known issues the vendor preemptively identifies a solution (step 42). When there are no impending failures and all potential problem areas have been identified and resolved the method moves to the planning phase. As above, in alternative embodiments, the planning phase can begin at some threshold level of achievement (e.g., known issues associated with impending failures are reduced by some criterion) during the proactive phase. Further, the proactive phase may continue being implemented in such embodiments.

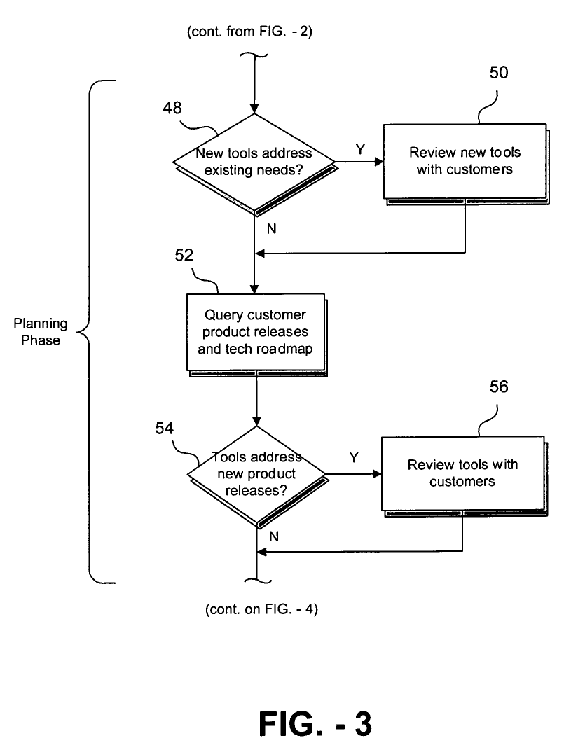

Referring to FIG. 3, during the planning phase the vendor determines whether new tools offered by the vendor address existing needs of the customer (step 48). Existing and/or new tools can be hardware-based or software-based, and can comprise proprietary or off-the-shelf technology. For example, software-based tools can include Clarify® software from Clarify, Inc. which can be used in sales and service automation (e.g., for open case database tracking) and Excel® spreadsheet software from Microsoft, Corp. which can be applied to analyze aggregated data. New tools can address existing needs by improving existing performance of the IT infrastructure (e.g., where performance is marginal) or new tools can address architectural problem spots identified during the reactive phase. Alternatively, the vendor can determine based on problem reporting database information and information gathered in the reactive phase if new tools can prevent impending failures. If new tools exist the vendor then reviews the new tools with the customer (step 50). The vendor then queries the customer product release and technology roadmap (step 52). The vendor assesses how effectively the existing IT infrastructure can manage the product releases and new technology. The vendor determines whether existing tools or new tools offered by the vendor address the new product releases in the technology roadmap (step 54). If the new or existing tools address new product releases the vendor reviews the tools with the customer in view of the new product releases and the technology roadmap (step 56).

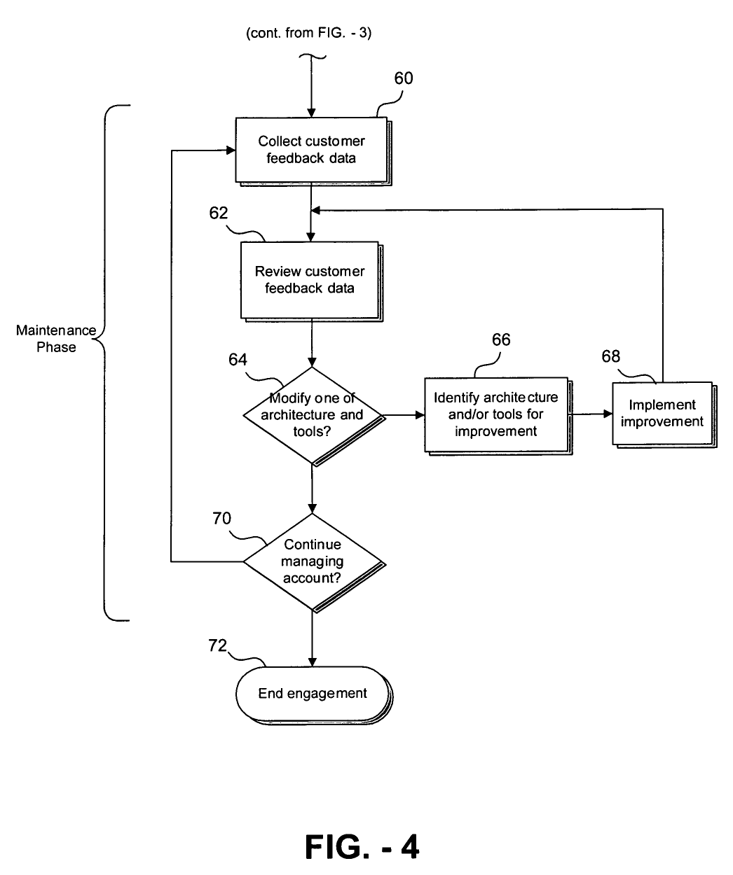

Referring to FIG. 4, the account then enters the maintenance phase. During the maintenance phase the vendor persistently collects customer feedback data (step 60). The vendor then reviews the customer feedback data (step 62) and determines whether to modify one of the architecture and the tools (step 64). If the vendor determines that modifications required the vendor identifies the architecture and/or the tools for improvement (step 66). the vendor then arranges to implement the improvement (step 68). If the vendor does not identify modifications to the architecture and/or the tools, the process of collecting customer feedback data and reviewing the customer feedback data until the account is no longer managed by the vendor (step 70). Application of the method ends when the vendor ceases to continue managing the account and the engagement ends (step 72).

Embodiments of methods of managing an IT service account in accordance with the present invention can reduce maintenance charges typically associated with IT administration. For example, a typical open ticket in the IT service industry can cost as much as $800 in fees to disposition. Engaging in steps as outlined in the method allows a service account manager (“SAM”), for example, to manage an account, directing and anticipating action taken on the account to reduce or eliminate unnecessary escalations. Such escalations can delay addressing problems and can reduce both the vendor and customer efficiency. Improving interaction between the customer and the vendor can improve the working relationship between the customer and the vendor, as well as reducing costs for both parties.

The present invention can be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes and/or steps of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A data processing system for managing an information technology service account comprising:
(a) computer processor means for processing data;
(b) storage means for storing data on a storage medium;
(c) second means for processing open case data for storing on the storage medium;
(d) third means for processing customer feedback data for storing on the storage medium;
(e) fourth means for identifying an architecture problem spot based on the open case data and the customer feedback data;
(f) fifth means for determining whether a technical resource is required to address the architecture problem spot and identifying the technical resource required;
(g) sixth means for processing reported problems data for storing on the storage medium;
(h) seventh means for determining whether a failure is impending based on the reported problems data and identifying a solution for the impending failure;
(i) eighth means for identifying a potential problem area based on the open case data, the customer feedback data and the reported problems data; and
(j) ninth means for identifying one of a tool and an architecture to modify the information technology service account based on the open case data, the customer feedback data and the reported problems data.

2. A method to manage an information technology service account comprising the steps of:
engaging a customer to establish the information technology service account;
training the customer on support;
assessing technical needs of the customer;
establishing a problem reporting procedure;
deploying the problem reporting procedure to the customer;
identifying known issues of the information technology service account based at least in part on the problem reporting procedure;
identifying solutions to the identified known issues;
determining additional or substitutive tools for the information technology service account based on the problem reporting procedure;
querying product releases of the customer;
querying technology roadmap of the customer;
determining additional or substitutive tools based on the product releases and technology roadmap;
collecting customer feedback data; and
determining modification of one or both of the previous steps and one or more tools based on the customer feedback data.

3. The method of claim 2, wherein assessing the technical needs of the customer further comprises the steps of:
determining whether an open case exists;
assigning technical resources to the open case;
assessing failure associated with the open case;
entering failure data related to the failure into database;
retrieving pre-existing customer feedback data; and
determining whether the information technology service account is stabile based on the pre-existing customer feedback data and the failure data.

4. The method of claim 3, wherein assessing the technical needs of the customer further comprises the steps of:
determining whether a problem spot exists;
determining whether a technical resource is required if the problem spot exists; and
identifying a technical specialist if the technical resource is required.

5. The method of claim 2, wherein the additional or substitutive tools are one or both of hardware-based tools and software-based tools.

6. A method to manage an information technology service account comprising the steps of:
engaging a customer to establish the information technology service account;
training the customer on support;
determining whether an open case exists;
wherein if the open case exists, the steps of:
assigning technical resources to the open case,
assessing failure associated with the open case,
entering failure data related to the failure into database,
retrieving pre-existing customer feedback data, and
determining whether the information technology service account is stabile based on the pre-existing customer feedback data and the failure data;
establishing a problem reporting procedure;
deploying the problem reporting procedure to the customer;
identifying known issues of the information technology service account based at least in part on the problem reporting procedure;
wherein if the known issues are identified, the step of:
identifying solutions to the identified known issues;
determining additional or substitutive tools for the information technology service account based on the problem reporting procedure;
querying product releases of the customer;
querying technology roadmap of the customer;
determining additional or substitutive tools based on the product releases and technology roadmap;
collecting customer feedback data; and
determining modification of one or both of the previous steps and one or more tools based on the customer feedback data.

7. The method of claim 6, wherein the additional or substitutive tools are one or both of hardware-based tools and software-based tools.
